(19) United States
(12) Patent Application Publication
(10) Pub. No.: US 2023/0262168 A1
(43) Pub. Date: Aug. 17, 2023

(54) MEETING MANAGEMENT APPARATUS, MEETING MANAGEMENT METHOD AND NON-TRANSITORY COMPUTER-READABLE MEDIUM

(71) Applicant: V-CUBE, INC., Tokyo (JP)

(72) Inventors: Yosuke KAMEZAKI, Tokyo (JP); Hironori NURISHI, Tokyo (JP); Ei SOU, Tokyo (JP); Ken KOSEKI, Tokyo (JP)

(21) Appl. No.: 18/303,566

(22) Filed: Apr. 20, 2023

Related U.S. Application Data
(63) Continuation of application No. PCT/JP2021/030378, filed on Aug. 19, 2021.

(30) Foreign Application Priority Data
Nov. 4, 2020 (JP) 2020-184303

(51) Int. Cl. H04M 3/56; G06Q 10/1093

(52) U.S. Cl. CPC H04M 3/563; G06Q 10/1095; H04M 3/568; H04M 2201/42

(57) ABSTRACT

A meeting management apparatus managing a plurality of group meetings that a plurality of users can attend using a communication terminal, the meeting management apparatus including: a terminal control part that executes a first meeting in which voices are transmitted and received between a plurality of the communication terminals used by the plurality of users; and an operation receiving part that receives, during or after execution of the first meeting, a selection operation for selecting a second user from among the plurality of users, performed by a first user among the plurality of users, wherein the terminal control part executes, during or after the execution of the first meeting, a second meeting in which voices are transmitted or received between the communication terminal used by the first user and the communication terminal used by the second user corresponding to the selection operation.

### CROSS-REFERENCE TO RELATED APPLICATIONS

The present application is a continuation application of International Application number PCT/JP2021/30378, filed on Aug. 19, 2021, which claims priority under 35 U.S.C § 119(a) to Japanese Patent Application No. 2020-184303, filed on Nov. 4, 2020. The contents of this application are incorporated herein by reference in their entirety.

### BACKGROUND OF THE INVENTION

The present disclosure relates to a meeting management apparatus, a meeting management method, and a computer-readable non-transitory storage medium for managing meetings performed via a network.

There is known a technique for performing a meeting by transmitting and receiving audio signals via a network. Japanese Unexamined Patent Application Publication No. 2020-144476 discloses a meeting system that enables the performance of a plurality of group meetings.

### BRIEF SUMMARY OF THE INVENTION

In a venue such as a product exhibition, an attendee can view presentations given by various exhibitor companies by visiting exhibition booths of a plurality of companies. The attendee can view presentations given by exhibitor companies via a network by using a group meeting function of a meeting system.

In a group meeting for a presentation of an exhibitor company, a person in charge of the exhibitor company generally gives an explanation using his/her voice to a plurality of attendees. For this reason, when an attendee speaks, it may interfere with other attendees, or an attendee may not be able to speak out at all. Further, it is difficult for the person in charge to have a conversation with only a specific attendee among a plurality of attendees attending the group meeting. Therefore, it is difficult for some users attending the same group meeting to communicate with each other.

The present disclosure focuses on these points, and its object is to facilitate communication among some users attending the same group meeting.

A meeting management apparatus according to a first aspect of the present disclosure is a meeting management apparatus managing a plurality of group meetings that a plurality of users can attend using a communication terminal, the meeting management apparatus including: a terminal control part that executes a first meeting in which voices are transmitted and received between a plurality of the communication terminals used by the plurality of users; and an operation receiving part that receives, during or after execution of the first meeting, a selection operation for selecting a second user from among the plurality of users, performed by a first user among the plurality of users, wherein the terminal control part executes, during or after the execution of the first meeting, a second meeting in which voices are transmitted or received between the communication terminal used by the first user and the communication terminal used by the second user corresponding to the selection operation.

A meeting management method according to a second aspect of the present disclosure is a meeting management method, executed by a computer, for managing a plurality of group meetings that a plurality of users can attend using a communication terminal, the meeting management method including: executing a first meeting in which voices are transmitted and received between a plurality of the communication terminals used by the plurality of users; receiving a selection operation for selecting a second user from among the plurality of users, performed by a first user among the plurality of users during or after execution of the first meeting; and transmitting and receiving voices between the communication terminal used by the first user and the communication terminal used by the second user corresponding to the selection operation during or after execution of the first meeting.

A storage medium according to a third aspect of the present disclosure is a computer-readable non-transitory storage medium storing a program for causing a computer to manage a plurality of group meetings that a plurality of users can attend using a communication terminal, the program causing the computer to execute: executing a first meeting in which voices are transmitted and received between a plurality of the communication terminals used by the plurality of users; receiving a selection operation for selecting a second user from among the plurality of users, performed by a first user among the plurality of users during or after execution of the first meeting; and transmitting and receiving voices between the communication terminal used by the first user and the communication terminal used by the second user corresponding to the selection operation during or after execution of the first meeting.

### BRIEF DESCRIPTION OF THE DRAWINGS

FIG. 1 shows a configuration of a meeting management system.

FIG. 2 shows an example of a screen for selecting a group meeting that an attendee will attend.

FIG. 3 shows an example of a screen in the group meeting.

FIG. 4 shows an example of a screen in the group meeting.

FIG. 5 shows configurations of a meeting management apparatus and an attendee terminal.

FIG. 6 shows an example of a group meeting screen displayed on the attendee terminal.

FIG. 7 shows an example of a group meeting screen displayed on the attendee terminal.

FIG. 8 shows an example of a group meeting screen displayed on the exhibitor terminal.

FIG. 9 shows an example of a group meeting screen displayed on an exhibitor terminal.

FIG. 10 shows an example of a group meeting screen displayed on the attendee terminal.

FIG. 11A shows an example of a screen for selecting a speaking user.

FIG. 11B shows an example of a screen indicating that a user has been selected as the speaking user.

FIG. 12A is a flowchart showing an example of a flow of processing in the meeting management apparatus.

FIG. 12B is a flowchart showing an example of a flow of processing in the meeting management apparatus.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Outline of a Meeting Management System S]

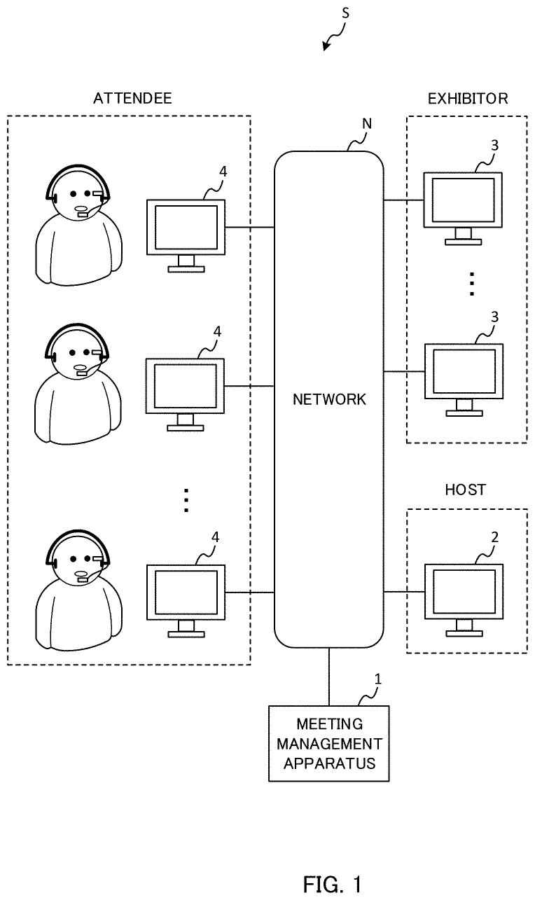

FIG. 1 shows a configuration of a meeting management system S. The meeting management system S is a system for enabling a plurality of group meetings to be performed online in parallel. The meeting management system S is suitable for an online event where people in charge of a plurality of exhibitor companies who wish to introduce their products or services and a plurality of attendees who wish to obtain information concerning products or services can exchange information, but the application of the meeting management system S is not limited.

In the example shown in FIG. 1, the meeting management system S includes a meeting management apparatus 1, a host terminal 2, a plurality of exhibitor terminals 3, and a plurality of attendee terminals 4. The meeting management apparatus 1 is a device for managing a plurality of group meetings that a plurality of attendees can attend using communication terminals. The meeting management apparatus 1 is a server that executes data processing for realizing a plurality of group meetings, and is managed by organizers (e.g., hosts of an event) of the plurality of group meetings, for example.

The meeting management apparatus 1 causes the plurality of exhibitor terminals 3 and the plurality of attendee terminals 4 to display a screen for attending the plurality of group meetings via a network N so that a plurality of people can attend the plurality of group meetings. The meeting management apparatus 1 provides an exhibitor terminal 3 and an attendee terminal 4 registered in advance with a web application, thereby allowing the exhibitor terminal 3 and the attendee terminal 4 to attend the group meeting. Details of the meeting management apparatus 1 will be described later.

The host terminal 2 is a communication terminal used by the organizers of the plurality of group meetings, and is, for example, a computer. An organizer performs various initial settings for the plurality of group meetings. For example, the organizer sets the number of people who can attend each group meeting, and sets the size of a booth corresponding to each group meeting in a layout diagram (map) of an event venue to be displayed on the plurality of exhibitor terminals 3 and the plurality of attendee terminals 4, via the host terminal 2.

The exhibitor terminal 3 is a communication terminal used by a person in charge of an exhibitor company that is to attend a group meeting (hereinafter referred to as “person in charge”), and is, for example, a computer, a tablet, or a smartphone. The exhibitor terminal 3 is disposed in an office of the exhibitor company, and is operated by one or more people in charge of the exhibitor company to transmit and receive various types of data to and from the attendee terminal 4 via the meeting management apparatus 1. The exhibitor terminal 3 transmits, to the meeting management apparatus 1, image data for a presentation, audio data of the person in charge, and text data input by the person in charge, for example.

The attendee terminal 4 is a communication terminal used by a visitor to an event who will attend a group meeting (hereinafter referred to as an “attendee”), and is, for example, a computer, a tablet, or a smartphone. The attendee terminal 4 is operated by the attendee to transmit and receive various types of data to and from the exhibitor terminal 3 or another attendee terminal 4 via the meeting management apparatus 1. The attendee terminal 4 receives image data, audio data, and text data transmitted from the exhibitor terminal 3 or another attendee terminal 4, and displays the received data on a screen.

The meeting management apparatus 1 generates various types of data for exchanging information between a plurality of people in charge and a plurality of attendees, and displays the generated, various types of data on screens of the exhibitor terminal 3 and the attendee terminal 4. The meeting management apparatus 1 displays an image indicating booths of the plurality of group meetings that can be attended using the plurality of attendee terminals 4 on the screen of the attendee terminal 4, and allows the attendee to select a group meeting that he/she wishes to attend. Further, the person in charge may attend a group meeting by operating an exhibitor terminal 3.

A person in charge using the exhibitor terminal 3 and the attendee using the attendee terminal 4 can communicate with each other by sending and receiving text messages to and from each other using a chat feature or by individually sending and receiving voices. The attendee can send text messages to ask questions while the person in charge of the exhibitor company is giving a presentation in the group meeting, or can have voice conversation with the person in charge individually after the presentation, for example. Further, a plurality of attendees using the attendee terminals 4 can communicate with each other by sending and receiving text messages to and from each other using the chat function or by individually sending and receiving voices.

### [Examples of Screens]

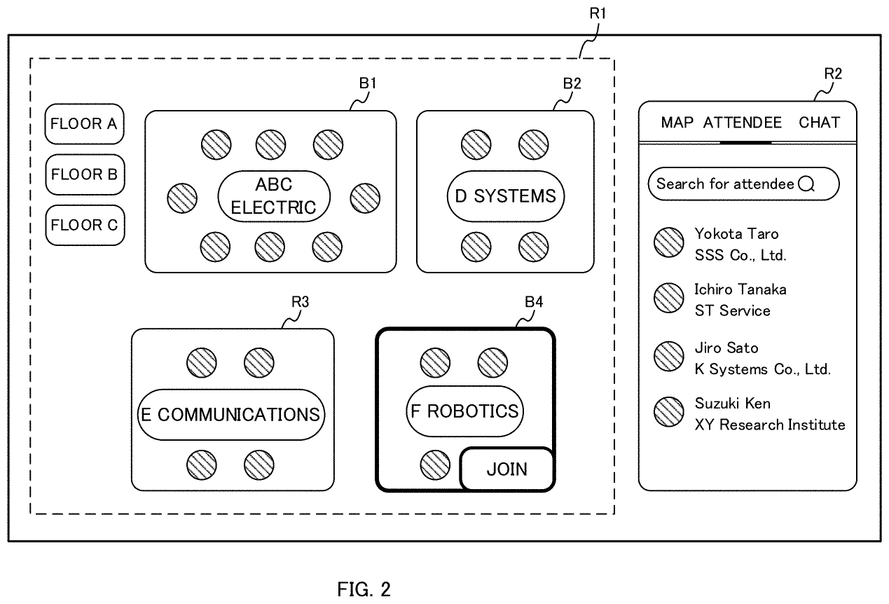

FIGS. 2 to 4 show examples of screens displayed on the attendee terminal 4.

FIG. 2 is a screen for selecting a group meeting that the attendee will attend. The names of exhibitor companies organizing group meetings are displayed in an area R1 of FIG. 2, as an outline of the plurality of group meetings. Specifically, the following group meetings are displayed: a group meeting of ABC Electric as a booth B1; a group meeting of D Systems as a booth B2; a group meeting of E Communications as a booth B3; and a group meeting of F Robotics as a booth B4.

An image of a circle with diagonal lines shown in each booth is an icon image corresponding to an attendee. Although the icon image in FIG. 2 is represented by diagonal lines, the icon image may be an image including information for identifying an attendee, such as a face image of the attendee.

The attendee can attend the group meeting corresponding to a selected booth by performing an operation for selecting a booth to attend on the screen of FIG. 2 (e.g., a click operation or a touch operation). FIG. 2 shows a state where the attendee has selected a group meeting of the booth B4.

Various types of information that the attendee can utilize are displayed on an area R2 of FIG. 2. Specifically, in the area R2, a list of attendees at the group meeting that the attendee is attending is displayed, a chat message exchanged with a person in charge is displayed, or a map indicating the layout of the venue is displayed. In FIG. 2, a list of attendees attending the group meeting of the booth B4 is displayed in response to the attendee selecting the group meeting of the booth B4.

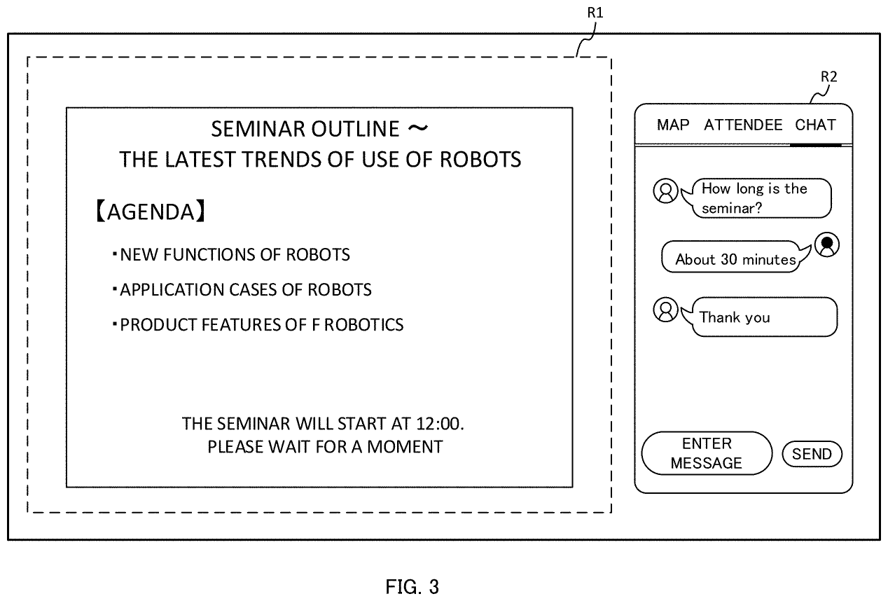

If the attendee selects a display area “Join” displayed on the selected booth B4 on the screen shown in FIG. 2, it is determined that the attendee is to attend the group meeting, and the attendee terminal 4 causes a screen in the group meeting to be displayed. FIG. 3 shows an example of a screen in the group meeting. Presentation materials prepared by the exhibitor company are displayed in an area R1 of FIG. 3. A screen for chatting is displayed in an area R2 of FIG. 3. The attendee can send and receive messages to and from a person in charge of the exhibitor company, using a chat screen displayed in the area R2. An operation image for switching whether to or not to send a voice or an image of the attendee may be provided in the area R1 of FIG. 3.

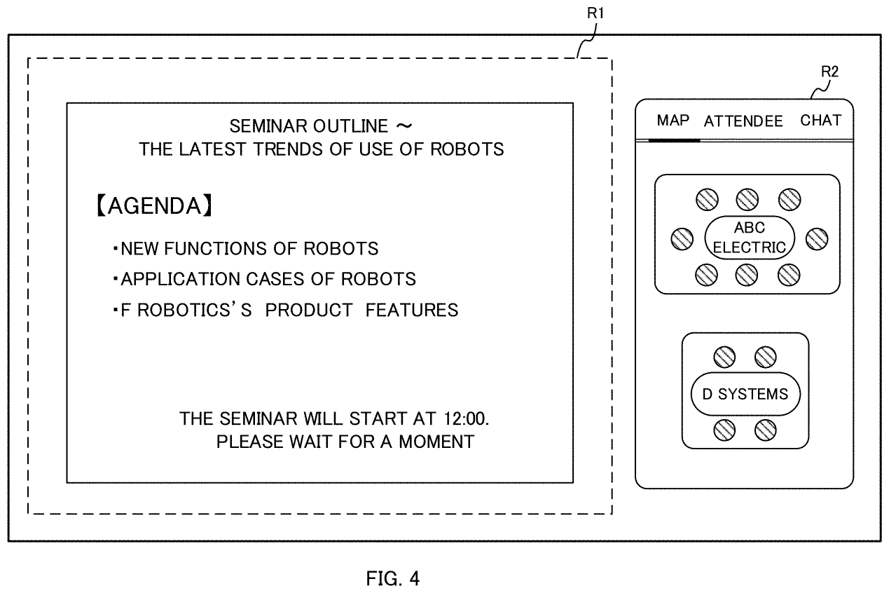

FIG. 4 shows another example of a screen in the group meeting. If the attendee selects a “map” in the area R2 of the screen shown in FIG. 3, the attendee terminal 4 displays the screen shown in FIG. 3. On this screen, an outline of each booth shown in the area R1 of FIG. 2 is displayed in a reduced size, and the attendee can check the states of other group meetings while attending the group meeting. The attendee can shift to another group meeting by performing an operation of selecting the other group meeting displayed in the area R2. In addition, at least one of image data of the person in charge captured by a camera of the exhibitor terminal 3 or image data of the attendee captured by a camera of the attendee terminal 4 may be displayed in the area R1 of FIGS. 3 and 4.

The meeting management system S according to the present embodiment executes a first meeting in which voices are transmitted and received between a plurality of communication terminals including at least one of the exhibitor terminal 3 or the attendee terminal 4. Further, during or after the execution of the first meeting, the meeting management system S receives a selection operation for selecting a second user, from among a plurality of users who are attending or who have attended the first meeting, by a first user among the plurality of users. During or after the execution of the first meeting, the meeting management system S executes a second meeting for transmitting and receiving voices between a communication terminal used by the first user and a communication terminal used by the selected second user.

According to the meeting management system S, the attendees attending the same group meeting can individually have a voice conversation among each other during the group meeting, and the person in charge can individually have a voice conversation with an attendee during or after the group meeting. Thus, the meeting management system S can facilitate communication among some users attending the same group meeting.

### [Outlines of the Meeting Management Apparatus 1 and the Attendee Terminal 4]

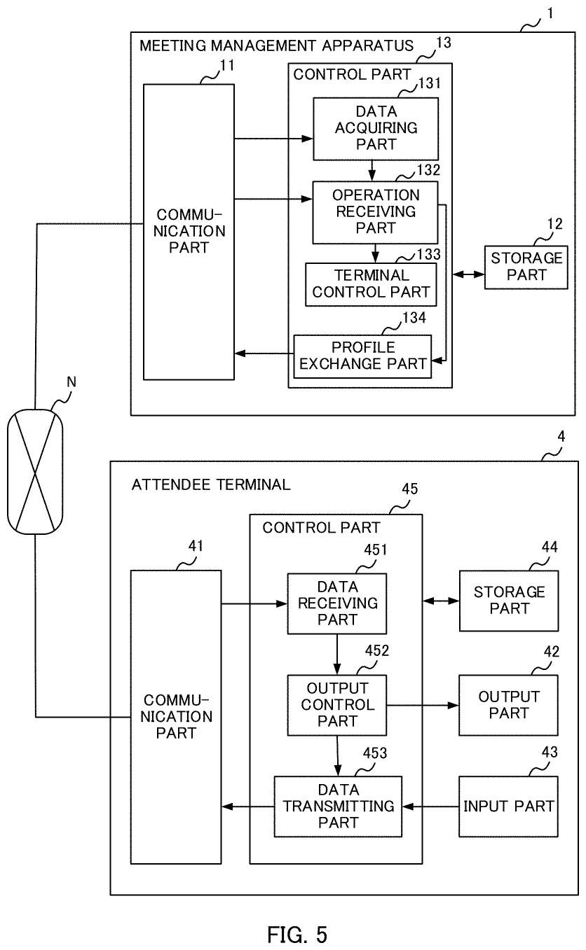

FIG. 5 shows configurations of the meeting management apparatus 1 and the attendee terminal 4. Since the host terminal 2 and the exhibitor terminal 3 have a configuration equivalent to that of the attendee terminal 4, a description thereof will be omitted.

The meeting management apparatus 1 includes a communication part 11, a storage part 12, and a control part 13. The control part 13 includes a data acquiring part 131, an operation receiving part 132, a terminal control part 133, and a profile exchange part 134.

The communication part 11 includes a communication controller for transmitting and receiving various types of data via the network N. The communication part 11 notifies the data acquiring part 131 of image data or sound data generated in a group meeting. Further, the communication part 11 notifies the operation receiving part 132 of data for a setting operation received from the host terminal 2, the exhibitor terminal 3, or the attendee terminal 4. Furthermore, the communication part 11 transmits the image data or sound data input from the terminal control part 133 to the host terminal 2, the exhibitor terminal 3, or the attendee terminal 4.

The storage part 12 includes storage media such as a Read Only Memory (ROM), a Random Access Memory (RAM), and a Solid State Drive (SSD). The storage part 12 stores a program executed by the control part 13. The storage part 12 stores various types of data related to the group meeting. The storage part 12 stores meeting attribute data indicating attributes of a group meeting in association with each of the plurality of group meetings, for example.

The storage part 12 stores profile data of each of the plurality of users including at least one of whom is a person in charge or an attendee. The storage part 12 stores profile data including the user's personal information, such as (i) his/her name, (ii) the name of a university or organization he/she belongs to, or (iii) birthplace, place of residence, hobby, gender, or age of the user, for example. In addition, the profile data may include a business category of the organization the user belongs to, or a business category or job type for which the user desires to find employment. Further, the profile data may include membership types indicating whether the user is a paying member who pays to attend the event or a non-paying member who attends the event free of charge.

The control part 13 includes a Central Processing Unit (CPU), for example. The control part 13 functions as the data acquiring part 131, the operation receiving part 132, the terminal control part 133, and the profile exchange part 134 by executing a program stored in the storage part 12. Details of the data acquiring part 131, the operation receiving part 132, the terminal control part 133, and the profile exchange part 134 will be described later.

The attendee terminal 4 includes a communication part 41, an output part 42, an input part 43, a storage part 44, and a control part 45. The control part 45 includes a data receiving part 451, an output control part 452, and a data transmitting part 453.

Similar to the communication part 11, the communication part 41 includes a communication controller for transmitting and receiving various types of data via the network N. The communication part 41 receives image data and sound data transmitted from the exhibitor terminal 3 via the network N and the meeting management apparatus 1, for example. The communication part 41 inputs the received data to the data receiving part 451. Further, the communication part 41 acquires, from the data transmitting part 453, sound data based on voice input by the attendee using the attendee terminal 4 and text data input by the attendee using the attendee terminal 4, and then transmits the acquired data.

The output part 42 includes a display that functions as a display displaying various types of image data, and a speaker that outputs sound data. In response to an instruction from the output control part 452, the output part 42 displays an image related to the group meeting as shown in FIGS. 2 to 4 on the display, and outputs, to the speaker, sounds generated in the group meeting that the attendee is attending. Further, the output part 42 displays the meeting attribute data on the display.

The input part 43 is a device that receives an operation made by the attendee using the attendee terminal 4, and is, for example, a keyboard, a mouse, or a touch panel. The input part 43 notifies the data transmitting part 453 of data based on an operation input by the attendee.

The storage part 44 includes storage media such as a ROM, a RAM, and an SSD. The storage part 44 stores a program executed by the control part 13.

The control part 45 includes a CPU, for example. The control part 45 functions as the data receiving part 451, the output control part 452, and the data transmitting part 453 by executing a program stored in the storage part 44.

The data receiving part 451 receives various types of data from the meeting management apparatus 1 via the communication part 41. The data receiving part 451 receives meeting attribute data indicating attributes of a plurality of group meetings, for example. The data receiving part 451 inputs the received meeting attribute data to the output control part 452.

The output control part 452 causes the output part 42 to output the data transmitted from the meeting management apparatus 1. The output control part 452 causes an image based on image data to be displayed on the display, and causes a speaker to output a sound based on sound data, for example. The output control part 452 causes the meeting attribute data transmitted from the meeting management apparatus 1 to be displayed at a position corresponding to the group meeting according to the meeting attribute data on the display (e.g., a position of a booth indicated by the meeting management apparatus 1).

The data transmitting part 453 transmits the data input by the attendee via the input part 43 to the meeting management apparatus 1. The data transmitting part 453 transmits information for identifying the group meeting selected by the attendee to the meeting management apparatus 1, for example.

### [Configuration of the Control Part 13]

Next, a configuration and operation of the control part 13 will be described in detail. The data acquiring part 131 acquires various types of data from the host terminal 2, the exhibitor terminal 3, and the attendee terminal 4 via the communication part 11. The data acquiring part 131 acquires image data for presentations from the exhibitor terminal 3, and acquires sound data indicating sounds generated by users of each terminal, from the exhibitor terminal 3 and the attendee terminal 4, for example. Further, the data acquiring part 131 may acquire at least one of the image data of the person in charge captured by the camera included in the exhibitor terminal 3 or the image data of the attendee captured by the camera included in the attendee terminal 4.

The data acquiring part 131 notifies the terminal control part 133 of the acquired image data and sound data. Further, the data acquiring part 131 acquires meeting attribute data indicating attributes of each of the plurality of group meetings. The data acquiring part 131 notifies the terminal control part 133 of the acquired meeting attribute data.

The operation receiving part 132 receives various operations from the attendee terminal 4 via the communication part 11. The operation receiving part 132 receives, from the attendee terminal 4, a selection operation for selecting at least one of the plurality of group meetings. The operation receiving part 132 receives an operation of selecting the group meeting by acquiring information for identifying the group meeting selected by the attendee from among the plurality of group meetings, as displayed on the screen shown in FIG. 2.

The operation receiving part 132 receives an operation to “join” by acquiring information for specifying that the attendee has performed an operation to “join” on the screen shown in FIG. 2. The attendee terminal 4 used by the attendee who performed the operation to “join” attends the group meeting corresponding to the operation among the plurality of group meetings.

The terminal control part 133 transmits various types of data to the exhibitor terminal 3 and the attendee terminal 4 via the communication part 11, thereby causing various screens to be displayed on the exhibitor terminal 3 and the attendee terminal 4. The terminal control part 133 displays the screens shown in FIGS. 2 to 4 on the attendee terminal 4 by transmitting data necessary for the attendee terminal 4 to display the screens shown in FIGS. 2 to 4, for example. Then, the terminal control part 133 executes the group meeting by relaying various types of data transmitted from the exhibitor terminal 3 and the attendee terminal 4, and allowing the exhibitor and the attendee to exchange various types of information.

During the execution of the group meeting, by transmitting image data for presentations to the attendee terminal 4, the terminal control part 133 displays a group meeting screen including information concerning the group meeting in which the attendee is participating, for example.

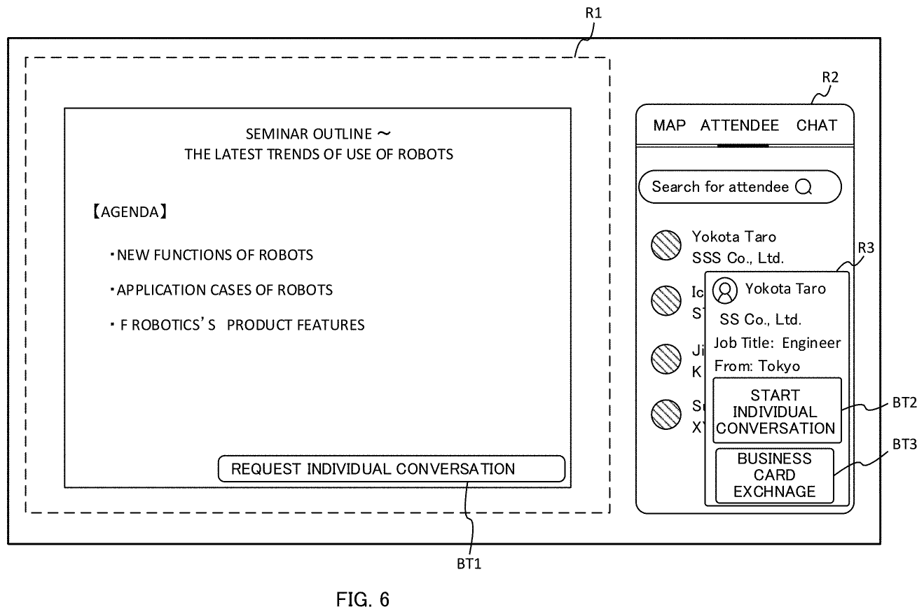

FIG. 6 shows an example of a group meeting screen displayed on the attendee terminal 4. A screen similar to the screen of FIG. 6 may be displayed on the exhibitor terminal 3. In an area R1, presentation materials prepared by the exhibitor company and an individual conversation request button BT1 for requesting an individual conversation with the person in charge of the exhibitor company are displayed. Further, in the area R1, instead of or in addition to the presentation materials, at least one of the image data of the person in charge captured by the camera included in the exhibitor terminal 3 or the image data of the attendee captured by the camera included in the attendee terminal 4 may be displayed.

A list of a plurality of users attending the group meeting is displayed in an area R2. The plurality of users displayed on the group meeting screen include at least one of an attendee or person in charge. When the operation receiving part 132 receives an operation of selecting any one of the plurality of users displayed in the area R2, the terminal control part 133 acquires the profile data of the selected user from the storage part 12 and causes the attendee terminal 4 to display the profile data. The attendee terminal 4 displays a user information area R3 including the profile data of the selected user.

In the user information area R3, the profile data of the selected user, an individual conversation start button BT2 for starting an individual conversation with the selected user, and a business card exchange button BT3 for transmitting the profile data to the selected user are displayed.

Processing executed by the meeting management apparatus 1 for enabling some users attending the group meeting to have a voice conversation will be described below. The terminal control part 133 executes a first meeting, which is a group meeting for transmitting and receiving voices between a plurality of communication terminals including the exhibitor terminal 3 and the attendee terminal 4. The first meeting is a group meeting such as a presentation performed between the exhibitor terminal 3 and the attendee terminal 4, for example.

In the first meeting, the terminal control part 133 transmits voice in one direction, from the exhibitor terminal 3 used by a person in charge who is one of the some users among the plurality of users to a plurality of attendee terminals 4 used by a plurality of attendees who are other users. By doing this, the meeting management apparatus 1 allows only a specific user to transmit voice to other users in the first meeting, thereby facilitating smooth progress of the presentation and the like. Further, the terminal control part 133 may cause the plurality of communication terminals (exhibitor terminals 3 or attendee terminals 4) attending the first meeting to transmit and receive text data by chat, email, or the like in addition to voice in the first meeting.

The operation receiving part 132 receives a selection operation for selecting the second user, from among the plurality of users, performed by the first user among the plurality of users during or after the execution of the first meeting. The selection operation is an operation in which an attendee who is the first user selects another attendee who is the second user, or an operation in which a person in charge who is the first user selects an attendee who is the second user.

During or after the execution of the first meeting, the terminal control part 133 executes a second meeting, which is a group meeting for transmitting and receiving voices between the communication terminal used by the first user and the communication terminal used by the second user corresponding to the selection operation.

In the second meeting, the terminal control part 133 transmits and receives voices bi-directionally between (i) the exhibitor terminal 3 or the attendee terminal 4 used by the person in charge or the attendee who is the first user and (ii) the attendee terminal 4 used by the attendee who is the second user. As a result, the meeting management apparatus 1 enables some users attending the first meeting to individually have a voice conversation in the second meeting, thereby facilitating communication. Further, the terminal control part 133 may cause a plurality of communication terminals (exhibitor terminals 3 or attendee terminals 4) attending the second meeting to transmit and receive text data by chat, email, or the like in addition to voice in the second meeting.

The meeting management apparatus 1 performs different processes for a case where attendees have an individual conversation among themselves and a case where an exhibitor and an attendee have an individual conversation. First, a specific process when the attendees have an individual conversation among themselves will be described.

During the execution of the first meeting, the operation receiving part 132 receives, from an attendee, a selection operation of selecting an individual conversation start button BT2 corresponding to another attendee who is desired to be a partner in an individual conversation on the group meeting screen of FIG. 6. The terminal control part 133 starts a second meeting in which voices are transmitted and received between the attendee terminal 4 used by a first user and the attendee terminal 4 used by a second user, the first user being the attendee who has performed the selection operation and the second user being the attendee corresponding to the selected individual conversation start button BT2. Further, the terminal control part 133 may transmit a notification of an invitation to the second meeting to the attendee terminal 4 used by the second user, and start the second meeting on condition that an operation for accepting to attend the second meeting is performed by the second user on the attendee terminal 4.

The terminal control part 133 may execute a second meeting in which only predetermined users, including the first user and the second user, can attend. In this case, the terminal control part 133 does not accept participation in the second meeting by a user other than the first user and the second user. By doing this, the terminal control part 133 can protect privacy in the second meeting. Further, the terminal control part 133 may execute a second meeting in which a user other than the first user and the second user can also attend. In this case, the terminal control part 133 may display a booth corresponding to the second meeting in a list of the booths on the screen of FIG. 2, and accept participation in the second meeting by a user other than the first user and the second user, for example.

During execution of the first meeting and the second meeting, the terminal control part 133 causes the attendee terminals 4 used by the first user and the second user to display a group meeting screen including information concerning the first meeting and the second meeting that the first user and the second user are attending, by transmitting image data for presentations in the first meeting and image data obtained by capturing users attending the second meeting, for example.

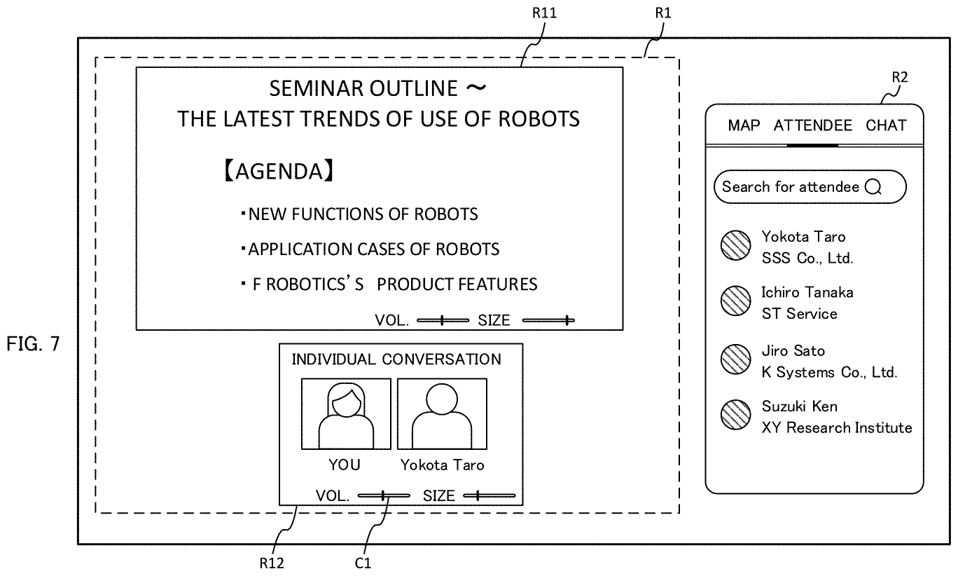

FIG. 7 shows an example of the group meeting screen displayed on the attendee terminal 4. A list of a plurality of users attending the first meeting is displayed in the area R2. The area R1 includes a first meeting area R11 including information concerning a first meeting and a second meeting area R12 including information concerning a second meeting.

Similar to FIG. 6, the presentation materials are displayed in the first meeting area R11. Further, in the first meeting area R11, instead of or in addition to the presentation materials, image data of at least one of a person in charge or an attendee who is attending the first meeting may be displayed. The image data is captured by a camera included in the exhibitor terminal 3 or the attendee terminal 4.

In the second meeting area R12, image data of an attendee who is the first user attending the second meeting and image data of an attendee who is the second user attending the second meeting captured by the camera included in the attendee terminal 4 are displayed. In this way, since the meeting management apparatus 1 causes the attendee terminal 4 to display both the information concerning the first meeting and the information concerning the second meeting at the same time, the user can easily attend the first meeting in parallel with the second meeting.

Further, the terminal control part 133 may independently adjust the volume of each of the first meeting and the second meeting and the screen size of each of the first meeting area R11 and the second meeting area R12. An adjustment column C1 for adjusting the volume and the screen size is displayed in each of the first meeting area R11 and the second meeting area R12. The operation receiving part 132 receives an adjustment operation for adjusting at least one of the volume or the screen size in the adjustment column C1 from the first user or the second user during execution of the first meeting and the second meeting. The adjustment operation performed on the adjustment column C1 of the first meeting area R11 is associated with the first meeting, and the adjustment operation performed on the adjustment column C1 of the second meeting area R12 is associated with the second meeting.

The terminal control part 133 adjusts either the first meeting or the second meeting corresponding to the adjustment operation, to have the volume or the screen size corresponding to the adjustment operation in the attendee terminal 4 used by the first user or the second user.

That is, the terminal control part 133 changes the volume of the first meeting or the screen size of the first meeting area R11 according to the change of the volume or the screen size in the adjustment column C1 of the first meeting area R11. The terminal control part 133 changes the volume of the second meeting or the screen size of the second meeting area R12 according to the change of the volume or the screen size in the adjustment column C1 of the second meeting area R12. By doing this, the volume or screen size of the first meeting and the second meeting can be adjusted independently, and therefore the meeting management apparatus 1 can improve convenience when the user attends the first meeting and the second meeting.

Second, a specific process when the person in charge and the attendee have an individual conversation will be described. During execution of the first meeting, the operation receiving part 132 receives, from an attendee, a selection operation of selecting the individual conversation request button BT1 indicating that he/she desires to attend a second meeting, i.e., to have an individual conversation with the person in charge, on the group meeting screen of FIG. 6.

During or after the execution of the first meeting, the terminal control part 133 transmits, to the exhibitor terminal 3, information indicating the attendee who has selected the individual conversation request button BT1 during the execution of the first meeting as a candidate user. The person in charge using the exhibitor terminal 3 is the first user.

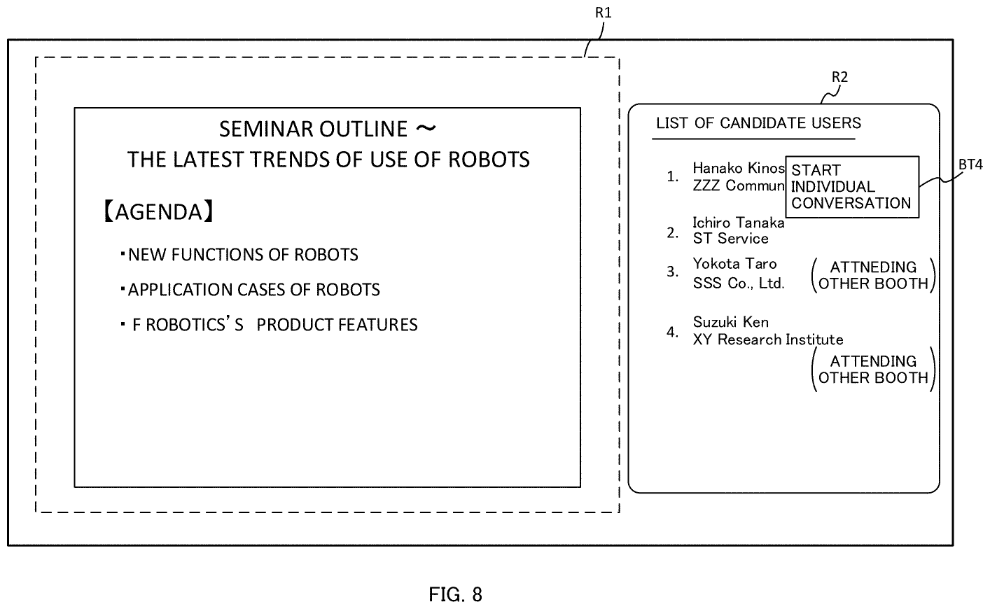

FIG. 8 shows an example of the group meeting screen displayed on the exhibitor terminal 3. In the area R1, presentation materials in the first meeting are displayed. When the first meeting ends, the list of the plurality of group meetings (booths) may be displayed in the area R1, similar to the screen of FIG. 2. In the area R2, a list of one or more candidate users who desire to attend the second meeting is displayed.

In addition, profile data of one or more candidate users may be displayed in the area R2. Further, in the area R2, information indicating whether each of the one or more candidate users is currently in another group meeting (booth) may be displayed. By doing this, the meeting management apparatus 1 can provide information for determining whether to select the second user, from among the one or more candidate users, to the person in charge who is the first user.

When any one of the candidate users is selected in the area R2, a candidate user selection button BT4 corresponding to the selected candidate user is displayed. During or after the execution of the first meeting, the operation receiving part 132 receives, from the person in charge, a selection operation of selecting the candidate user selection button BT4 corresponding to the candidate user who is desired to be a partner in the individual conversation on the group meeting screen of FIG. 8.

The terminal control part 133 starts the second meeting in which voices are transmitted and received between the exhibitor terminal 3 used by a first user and the attendee terminal 4 used by a second user, the first user being the person in charge of the selection operation and the second user being the attendee corresponding to the selected candidate user selection button BT4. Further, the terminal control part 133 may transmit a notification of an invitation to the second meeting to the attendee terminal 4 used by the second user, and start the second meeting on condition that an operation for accepting to attend the second meeting is performed by the second user on the attendee terminal 4.

There are cases where a plurality of people in charge belong to an exhibitor company involved in a group meeting. In such a case, the terminal control part 133 may cause a plurality of exhibitor terminals 3 used by the plurality of people in charge who are the first users to display the list of candidate users. The operation receiving part 132 receives a selection operation for selecting a second user, from among the one or more candidate users, by any one of the plurality of people in charge. The terminal control part 133 starts a second meeting in which voices are transmitted and received between the exhibitor terminal 3 used by the person in charge who performed the selection operation and the attendee terminal 4 used by the second user corresponding to the selection operation. In this manner, the plurality of people in charge can start the second meeting with any one of the one or more candidate users in parallel, and therefore the meeting management apparatus 1 can efficiently execute the second meeting.

During execution of the first meeting and the second meeting, the terminal control part 133 causes the exhibitor terminal 3 used by the person in charge who is the first user to display a group meeting screen including information concerning the first meeting and the second meeting that the first user is attending, by transmitting image data for presentations in the first meeting, image data obtained by capturing users attending the second meeting, and information indicating the candidate user, for example. The screen of FIG. 7 is displayed on the attendee terminal 4 used by the attendee who is the second user.

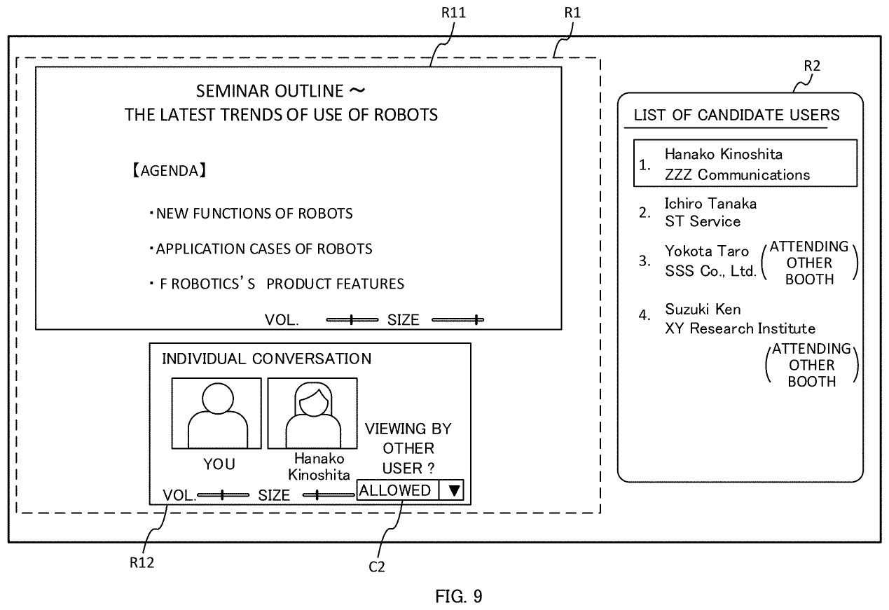

FIG. 9 shows an example of the group meeting screen displayed on the exhibitor terminal 3. In the area R2, a list of one or more candidate users who desire to attend the second meeting is displayed. The area R1 includes a first meeting area R11 including information concerning a first meeting and a second meeting area R12 including information concerning a second meeting.

Similar to FIG. 6, the presentation materials are displayed in the first meeting area R11. Further, in the first meeting area R11, instead of or in addition to the presentation materials, image data of at least one of a person in charge or an attendee who is attending the first meeting may be displayed. The image data is captured by a camera included in the exhibitor terminal 3 or the attendee terminal 4. When the first meeting ends, the list of the plurality of group meetings (booths) may be displayed in the first meeting area R11, similar to the screen of FIG. 2.

In the second meeting area R12, (i) image data of a person in charge who is the first user attending the second meeting and (ii) image data of the attendee who is the second user attending the second meeting are displayed. These pieces of image data are respectively captured by a camera included in the exhibitor terminal 3 and a camera included in the attendee terminal 4. In this way, since the meeting management apparatus 1 causes the exhibitor terminal 3 to display both the information concerning the first meeting and the information concerning the second meeting at the same time, the user can easily attend the first meeting in parallel with the second meeting.

The terminal control part 133 controls whether or not voices of the second meeting are allowed to be listened to by another user different from the first user and the second user among the plurality of users attending the group meeting. In the second meeting area R12 of the screen of FIG. 9, a permission column C2 for setting whether or not another user is allowed to listen to voices of the second meeting is displayed. Similarly, the permission column C2 may be displayed on the screen of FIG. 7 displayed on the attendee terminal 4.

The operation receiving part 132 receives, from the first user or the second user, a permission operation for allowing another user to listen to voices of the second meeting in the permission column C2 during execution of the second meeting. Another user is a person in charge different from the person in charge, who is the first user, among the plurality of people in charge belonging to the exhibitor company involved in the group meeting, for example. When the permission operation is performed, the terminal control part 133 transmits voices of the second meeting to the exhibitor terminal 3 or the attendee terminal 4 used by another user. By doing this, the meeting management apparatus 1 can switch whether or not to allow another user to listen to voices of the second meeting according to the operation by the user, and can control the degree of privacy protection of the second meeting.

Further, the terminal control part 133 may transmit voices of the second meeting to the exhibitor terminal 3 or the attendee terminal 4 used by another user having a predetermined user attribute regardless of the permission operation in the permission column C2, said another user being a user who is different from the first user and the second user among the plurality of users attending the group meeting. The predetermined user attribute is having the authority to manage the person in charge who is the first user, for example. By doing this, the meeting management apparatus 1 can allow a specific user to listen to voices of the second meeting regardless of the permission operation, and an administrator can easily manage the second meeting.

Further, the terminal control part 133 may cause the attendee terminals 4 used by each of the plurality of candidate users to display an estimated waiting time expected before being able to join the second meeting. In this case, the terminal control part 133 predicts the estimated waiting time on the basis of the number of the plurality of candidate users, for example. For example, the terminal control part 133 calculates the estimated waiting time by multiplying the number of the plurality of candidate users by a statistic value (mean value or median value) of a duration of the past second meeting. The terminal control part 133 causes the screen of FIG. 6 to display the expected waiting time by transmitting the estimated waiting time to the attendee terminals 4 used by the plurality of candidate users, for example. As a result, the meeting management apparatus 1 provides notification about the probability of a waiting time to the attendees who desire individual conversations, and enables the attendees to easily determine whether or not to attend another group meeting.

The terminal control part 133 may cause a third user different from the first user and the second user to attend the second meeting in both the case where the attendees have the individual conversation among themselves and the case where the person in charge and the attendee have the individual conversation. In this case, the operation receiving part 132 receives, from the first user or the second user, a selection operation for selecting the third user different from the first user and the second user from among the plurality of users during execution of the second meeting, for example. During execution of the second meeting, the terminal control part 133 executes the second meeting by transmitting and receiving voices between the communication terminal used by the first user, the communication terminal used by the second user, and the communication terminal used by the selected third user. As a result, the meeting management apparatus 1 can cause other users to attend the second meeting that is attended by the first user and the second user, and can therefore improve user convenience.

The profile exchange part 134 exchanges virtual business cards, i.e., profile data, between users according to an operation by the user. During or after execution of the first meeting, the operation receiving part 132 receives a selection operation for selecting a destination user from among a plurality of users as a transmission destination of the profile data including personal information, performed by a source user among the plurality of users. The operation receiving part 132 receives, as the selection operation of the destination user, an operation of selecting the business card exchange button BT3 corresponding to any user on the screen of FIG. 6, for example. The operation receiving part 132 may receive a selection operation of selecting one destination user or a selection operation of selecting a plurality of destination users at the same time.

The profile exchange part 134 acquires the profile data of the source user from the storage part 12, and transmits the profile data to the exhibitor terminal 3 or the attendee terminal 4 used by the destination user corresponding to the selection operation. The profile exchange part 134 may receive, from the source user, a selection of information to be transmitted to the destination user within the profile data. The attendee terminal 4 displays the received profile data on the group meeting screen.

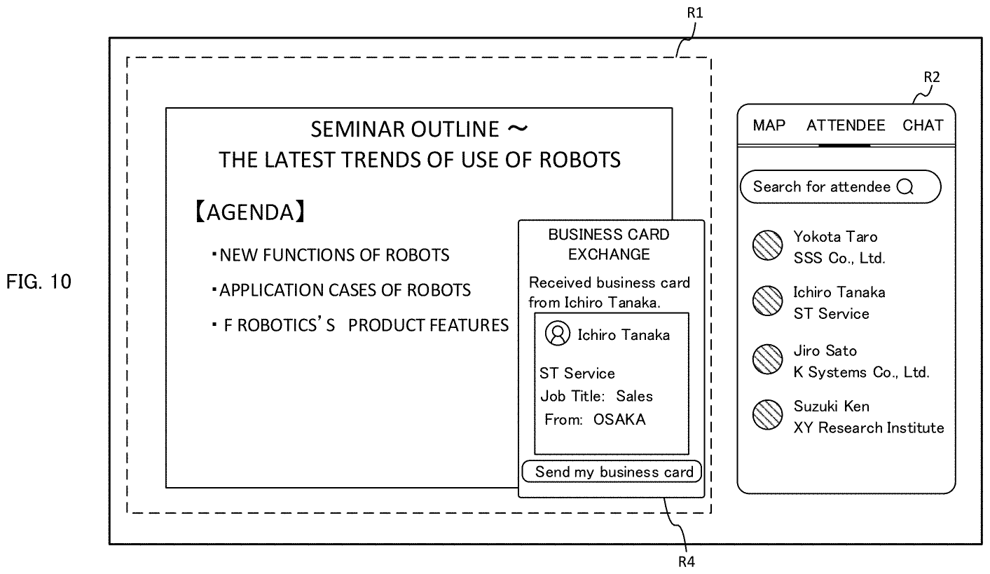

FIG. 10 shows an example of the group meeting screen displayed on the attendee terminal 4. A screen similar to that shown in FIG. 10 may be displayed on the exhibitor terminal 3. In the group meeting screen of FIG. 10, profile data of the source user is displayed in a business card display area R4. By doing this, the meeting management apparatus 1 enables the source user to proactively present his/her profile data to the destination user, and can realize communication similar to the business card exchange.

When a predetermined operation such as a button selection is performed in the business card display area R4, the profile exchange part 134 acquires the profile data of the destination user from the storage part 12, and transmits the profile data to the exhibitor terminal 3 or the attendee terminal 4 used by the source user who performed the selection operation. By doing this, the meeting management apparatus 1 facilitates exchange of profile data between users and facilitates smooth communication.

Further, the profile exchange part 134 may automatically transmit the profile data of the destination user to the exhibitor terminal 3 or the attendee terminal 4 used by the source user when transmitting the profile data of the source user to the exhibitor terminal 3 or the attendee terminal 4 used by the destination user. By doing this, the meeting management apparatus 1 can reduce the time and effort needed for exchanging profile data between users.

In the first meeting described above, the terminal control part 133 transmits voice in one direction, from some users among the plurality of users to other users. The terminal control part 133 may receive designation of a speaking user (also referred to as a speaker) that permits transmission of voice from a host of the event. In this case, the operation receiving part 132 receives an operation of selecting one or more users as speaking users from the host terminal 2, for example.

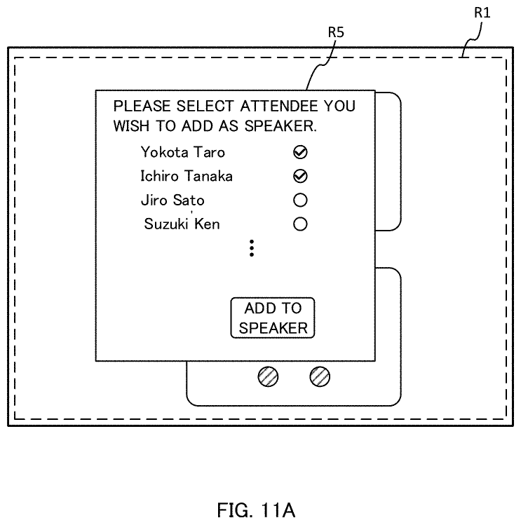

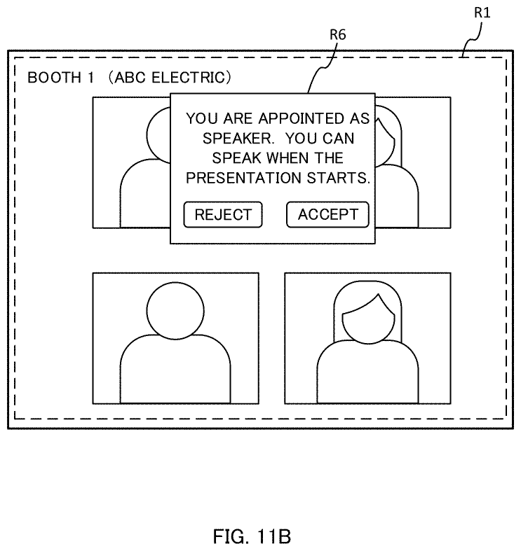

FIG. 11A shows an example of a screen for selecting the speaking user displayed on the host terminal 2. On the screen of FIG. 11A, an area R5 for selecting the speaking user from among the plurality of users is displayed. The operation receiving part 132 notifies the terminal control part 133 of information indicating one or more users selected in the area R5.

The terminal control part 133 causes the exhibitor terminal 3 or the attendee terminal 4 used by each of the selected one or more users to display information indicating that he/she has been selected as the speaking user. FIG. 11B shows an example of a screen indicating that the user has been selected as the speaking user displayed on the exhibitor terminal 3 or the attendee terminal 4. An area R6 for selecting whether to consent to become a speaking user is displayed on the screen of FIG. 11B. The operation receiving part 132 notifies the terminal control part 133 of information indicating whether to consent to become the speaking user selected in the area R6.

In the first meeting, the terminal control part 133 causes the exhibitor terminal 3 or the attendee terminal 4 used by the user who gave his/her consent to become the speaking user among the plurality of users to transmit voice in one direction to the exhibitor terminal 3 or the attendee terminal 4 used by other users. By doing this, the meeting management apparatus 1 receives designation of the user who can transmit voice in the first meeting by the host, and can flexibly perform the group meeting such as a presentation.

### [Processing Flow in the Meeting Management Apparatus 1]

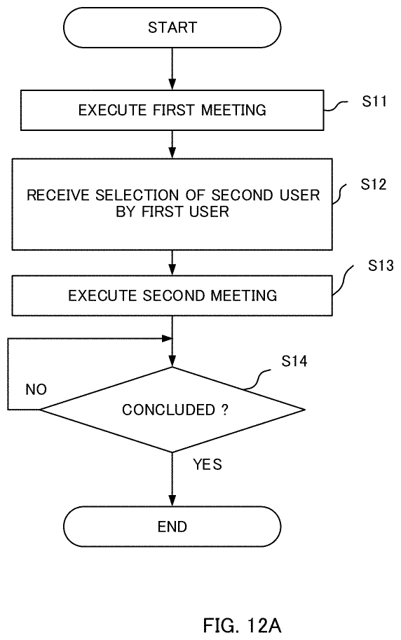

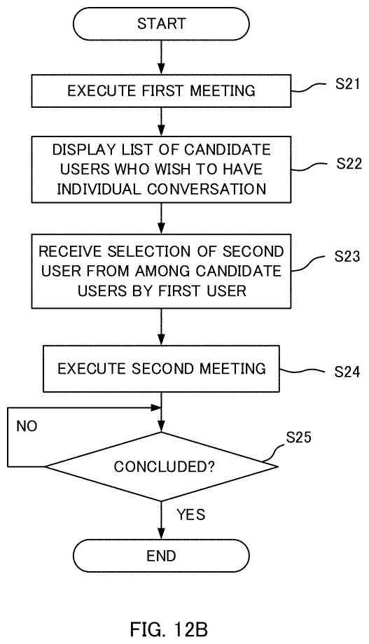

FIGS. 12A and 12B each show a flowchart showing an example of a flow of processing in the meeting management apparatus 1. FIG. 12A shows processing when the attendees have an individual conversation among themselves, and FIG. 12B shows processing when the person in charge and the attendee have an individual conversation.

In the flowchart of FIG. 12A, the terminal control part 133 executes a first meeting in which voices are transmitted and received between a plurality of communication terminals including the exhibitor terminal 3 and the attendee terminal 4 (S11). During execution of the first meeting, the operation receiving part 132 receives, from an attendee who is a first user, a selection operation of selecting an attendee who is a second user and desired to be a partner in the individual conversation (S12).

The terminal control part 133 starts a second meeting in which voices are transmitted and received between (i) an attendee terminal 4 used by the first user who is the attendee who performed the selection operation and (ii) an attendee terminal 4 used by the second user who is the selected attendee (S13).

The terminal control part 133 continues the group meeting until the terminal control part 133 receives an instruction to conclude the group meeting from the host terminal 2, the exhibitor terminal 3, or the attendee terminal 4 (NO in S14), for example. For example, when the terminal control part 133 receives the instruction to conclude the group meeting from the host terminal 2, the exhibitor terminal 3, or the attendee terminal 4 (YES in S14), the terminal control part 133 concludes the group meeting. When one of the first meeting and the second meeting is concluded, the terminal control part 133 may continue the other of the first meeting and the second meeting.

In the flowchart of FIG. 12B, the terminal control part 133 executes a first meeting in which voices are transmitted and received between a plurality of communication terminals including the exhibitor terminal 3 and the attendee terminal 4 (S21). During execution of the first meeting, the operation receiving part 132 receives a selection operation indicating that an individual conversation with a person in charge is requested by an attendee. During or after the execution of the first meeting, the terminal control part 133 displays a list of attendees, i.e., candidate users, who desire individual conversations with the person in charge during the execution of the first meeting on the exhibitor terminal 3 (S22).

The operation receiving part 132 receives, during or after execution of the first meeting, a selection operation of selecting, as the second user, any one attendee from among the candidate users, performed by the person in charge who is the first user (S23). The terminal control part 133 starts a second meeting in which voices are transmitted and received between (i) an exhibitor terminal 3 used by the first user who is the person in charge who has performed the selection operation and (ii) an attendee terminal 4 used by the second user who is the selected attendee (S24).

The terminal control part 133 continues the group meeting until the terminal control part 133 receives an instruction to conclude the group meeting from the host terminal 2, the exhibitor terminal 3, or the attendee terminal 4 (NO in S25), for example. For example, when the terminal control part 133 receives the instruction to conclude the group meeting from the host terminal 2, the exhibitor terminal 3, or the attendee terminal 4 (YES in S25), the terminal control part 133 concludes the group meeting. When one of the first meeting and the second meeting is concluded, the terminal control part 133 may continue the other of the first meeting and the second meeting.

### [Effect of the Meeting Management System S]

As described above, the meeting management apparatus 1 executes the first meeting in which voices are transmitted and received between the plurality of communication terminals, and receives the selection operation for selecting the second user from among the plurality of users that are attending or have attended the first meeting, performed by the first user during or after the execution of the first meeting. During or after execution of the first meeting, the meeting management system S executes the second meeting in which voices are transmitted and received between the communication terminal used by the first user and the communication terminal used by the selected second user.

According to the meeting management system S, the attendees attending the same group meeting can individually have a voice conversation during the group meeting, and the person in charge can individually have a voice conversation with the attendee during or after the group meeting. As a result, the meeting management apparatus 1 can facilitate communication among some users attending the same group meeting.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A meeting management apparatus managing a plurality of group meetings that a plurality of users can attend using a communication terminal, the meeting management apparatus comprising:
a terminal control part that executes a first meeting in which voices are transmitted and received between a plurality of the communication terminals used by the plurality of users; and
an operation receiving part that receives, during or after execution of the first meeting, a selection operation for selecting a second user from among the plurality of users, performed by a first user among the plurality of users, wherein
the terminal control part executes, during or after the execution of the first meeting, a second meeting in which voices are transmitted or received between the communication terminal used by the first user and the communication terminal used by the second user corresponding to the selection operation.

2. The meeting management apparatus according to claim 1, wherein the terminal control part transmits voice in one direction, from the communication terminal used by one or more users who are some of the plurality of users to the communication terminal used by one or more other users in the first meeting, and transmits and receives voices bi-directionally between the communication terminal used by the first user and the communication terminal used by the second user in the second meeting.

3. The meeting management apparatus according to claim 1, wherein
the operation receiving part receives, during execution of the second meeting, a selection operation for selecting a third user from among the plurality of users from the first user or the second user, and
the terminal control part transmits and receives, during execution of the second meeting, voices between the communication terminal used by the first user, the communication terminal used by the second user, and the communication terminal used by the third user.

4. The meeting management apparatus according to claim 1, wherein
the terminal control part executes the second meeting in which only predetermined users including the first user and the second user can attend.

5. The meeting management apparatus according to claim 1, wherein
the operation receiving part receives, during execution of the first meeting and the second meeting, an adjustment operation for adjusting at least one of the volume or a screen size of the communication terminal in association with the first meeting or the second meeting from the first user or the second user, and
the terminal control part adjusts either the first meeting or the second meeting corresponding to the adjustment operation to the volume or the screen size corresponding to the adjustment operation in the communication terminal used by the first user or the communication terminal used by the second user.

6. The meeting management apparatus according to claim 1, wherein
the terminal control part causes the communication terminal used by the first user to display, during execution of the first meeting, a list of one or more candidate users who desire to attend the second meeting, and
the operation receiving part receives a selection operation for selecting the second user from among the plurality of candidate users, performed by the first user.

7. The meeting management apparatus according to claim 6, wherein
the terminal control part causes a plurality of the communication terminals used by a plurality of the first users to display a list of the candidate users,
the operation receiving part receives the selection operation for selecting the second user from among the plurality of candidate users, performed by any one of the plurality of first users, and
the terminal control part executes a second meeting in which voices are transmitted or received between the communication terminal used by the first user who performed the selection operation and the communication terminal used by the second user indicated by the selection operation.

8. The meeting management apparatus according to claim 6, wherein the terminal control part causes the communication terminal used by each of the plurality of candidate users to display an estimated waiting time expected before being able to join the second meeting.

9. The meeting management apparatus according to claim 1, wherein
the operation receiving part receives a permission operation for allowing a user different from the first user and the second user among the plurality of users to listen to voices of the second meeting, performed by the first user or the second user, and
the terminal control part transmits voices of the second meeting to the communication terminal used by the user different from the first user and the second user among the plurality of users when the permission operation is performed.

10. The meeting management apparatus according to claim 1, wherein the terminal control part transmits voices of the second meeting to the communication terminal used by a user having a predetermined user attribute and is different from the first user and the second user among the plurality of users.

11. The meeting management apparatus according to claim 1, wherein
the operation receiving part receives, during or after execution of the first meeting, a selection operation for selecting a destination user from among the plurality of users as a transmission destination of profile data including personal information, performed by a source user among the plurality of users, and
the meeting management apparatus further includes
a profile exchange part that transmits the profile data of the source user to the communication terminal used by the destination user corresponding to the selection operation.

12. The meeting management apparatus according to claim 11, wherein
the profile exchange part transmits the profile data of the destination user to the communication terminal used by the source user when transmitting the profile data of the source user to the communication terminal used by the destination user.

13. A meeting management method, executed by a computer, for managing a plurality of group meetings that a plurality of users can attend using a communication terminal, the meeting management method comprising:
executing a first meeting in which voices are transmitted and received between a plurality of the communication terminals used by the plurality of users;
receiving a selection operation for selecting a second user from among the plurality of users, performed by a first user among the plurality of users during or after execution of the first meeting; and
transmitting and receiving voices between the communication terminal used by the first user and the communication terminal used by the second user corresponding to the selection operation during or after execution of the first meeting.

14. A computer-readable non-transitory storage medium storing a program for causing a computer to manage a plurality of group meetings that a plurality of users can attend using a communication terminal, the program causing the computer to execute:
executing a first meeting in which voices are transmitted and received between a plurality of the communication terminals used by the plurality of users;
receiving a selection operation for selecting a second user from among the plurality of users, performed by a first user among the plurality of users during or after execution of the first meeting; and
transmitting and receiving voices between the communication terminal used by the first user and the communication terminal used by the second user corresponding to the selection operation during or after execution of the first meeting.
